(19) United States
(12) Patent Application Publication
(10) Pub. No.: US 2017/0322537 A1
(43) Pub. Date: Nov. 9, 2017

(54) Processing Apparatus with Vision-Based Measurement

(71) Applicant: FACTORY AUTOMATION TECHNOLOGY CO., LTD., Chiayi County (TW)

(72) Inventors: PO CHENG SU, Chiayi County (TW); Hsin Hong Hou, Chiayi County (TW); Fan Tien Cheng, Chiayi County (TW); Haw Ching Yang, Chiayi County (TW); Hao Tieng, Chiayi County (TW)

(21) Appl. No.: 15/587,345

(22) Filed: May 4, 2017

(30) Foreign Application Priority Data
May 4, 2016 (TW) 105206394

(51) Int. Cl. G05B 19/401; B25J 9/16; G06K 9/00

(52) U.S. Cl. CPC G05B 19/401; G06K 9/00664; B25J 9/1697; G05B 2219/37561

(57) ABSTRACT

A processing apparatus with vision-based measurement includes a central control unit and a workpiece transporting unit, a vision-based measurement unit, a processing quality prediction unit, and a processing unit that are respectively connected to the central control unit electrically. The workpiece transporting unit is controlled by the central control unit to transport the workpiece to the vision-based measurement unit to be measured. The data obtained by the vision-based measurement unit from measuring the workpiece is provided to the processing quality prediction unit for conducting quality prediction. The processing quality prediction unit implements a virtual processing quality prediction method to establish a quality prediction model, wherein the workpiece transporting unit is utilized to assist the processes of establishing or modifying the model. The vision-based measurement unit can optically take photograph of the workpiece rapidly and convert it into a dimension data so as to facilitate the processing device to enhance the measuring efficiency.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a processing apparatus with vision-based measurement, and more particularly to a processing apparatus that utilizes image of the workpiece to measures the dimensions of workpiece.

### Description of Related Arts

Conventional numerical control processing apparatus converts design blueprint file and processing or machining parameters into processing or machining path when conducting workpiece processing for improving the processing efficiency and quality. Nowadays, processing technology and computer science evolve rapidly, it becomes possible to predict processing quality during the processing or machining procedures and correct the processing path proactively, so that the processing quality of the workpiece is improved accordingly. A prediction method of processing quality of workpiece, for example, has been disclosed in Taiwan Pat. No. TWI481978 B, entitled “Method for predicting machining quality of machine tool” (claiming priority of U.S. Pat. No. 61/722,250). It mainly converts information of a complete design into processing path and set accuracy category of product to coordinate with the data matching of the measurement to establish a processing model. It also keeps modifying and building its processing model. During the process of modifying and building the processing model, the workpiece to be processed is measured to provide information of its quality. Nonetheless, conventional measuring method still relies on three-dimensional metrology machine to implement the measurement. Unfortunately, such measurement implementation is inefficient.

### SUMMARY OF THE PRESENT INVENTION

Therefore, an object of the present invention is to provide a processing device with vision-based measurement that can enhance the measuring efficiency.

Accordingly, the processing device with vision-based measurement according to the present invention comprises a central control unit and a workpiece transporting unit, a vision-based measurement unit, a processing quality prediction unit, and a processing unit respectively connected to the central control unit electrically. The workpiece transporting unit is controlled by the central control unit to transport the workpiece to the vision-based measurement unit for measurement. The data obtained by the vision-based measurement unit from measuring the workpiece is provided to the processing quality prediction unit for conducting quality prediction. The processing quality prediction unit implements a virtual processing quality prediction method to establish a quality prediction model, so as to predict the processing quality of the workpiece and to generate processing path for the processing unit to process the workpiece. During the process of establishing the prediction model or modifying model by the processing quality prediction unit, the vision-based measurement unit is able to take optical photograph of the workpiece rapidly by means of the workpiece transporting unit and convert it into dimension data so as to enable the processing device to achieve better measuring efficiency.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram illustrating a processing device with vision-based measurement according to the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

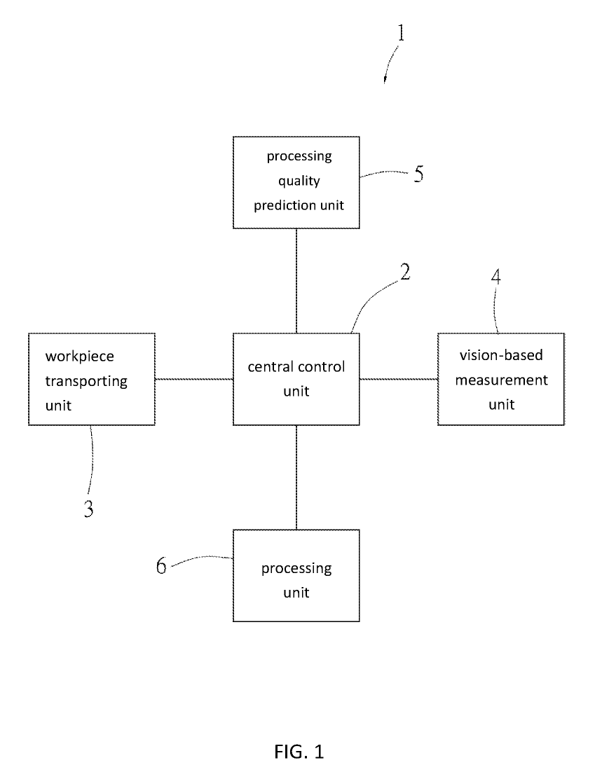

Referring to FIG. 1, a processing apparatus with vision-based measurement 1 for processing a workpiece according to a preferred embodiment of the present invention is illustrated. The processing apparatus with vision-based measurement 1 comprises a central control unit 2, a workpiece transporting unit 3, a vision-based measurement unit 4, a processing quality prediction unit 5, and a processing unit 6, wherein the workpiece transporting unit 3, the vision-based measurement unit 4, the processing quality prediction unit 5, and the processing unit 6 are respectively connected to the central control unit 2 electrically. In this preferred embodiment, the workpiece transporting unit 3 is embodied as a robot arm that is controlled by the central control unit 2 to timely clamp and transport the workpiece into an illumination scope of the vision-based measurement unit 4 for measurement and to transmit the information regarding the characteristics of the type of the workpiece moved to the central control unit 2. The vision-based measurement unit 4 comprises an industrial camera, a visual light source unit and a computing unit. When the workpiece transporting unit 3 transports the workpiece into the illumination scope of a visual light source, it makes the industrial camera to photograph the workpiece to obtain an image and has the computing unit to implement a dimension calculation so as to quickly obtain the dimension data of the workpiece and provide the dimension data to the processing quality prediction unit 5 to predict the processing quality.

The processing quality prediction unit 5 utilizes the technology disclosed in Taiwan Pat. No. TWI481978B, entitled “Method for predicting machining quality of machine tool.” It mainly applies computer-aided design (CAD) to produce the outline, dimensions, and tolerance of the workpiece and uses Computer Aided Manufacturing (CAM) to generate processing path based on the above dimensions and tolerance as well as the characteristics of the processing unit 6. Also, when the processing quality prediction unit 5 establishes the quality prediction model, at least a product accuracy category has to be assigned. The product accuracy category comprises roughness and/or dimension deviation, and etc. The dimension deviation comprises straightness, angularity, perpendicularity, parallelism, and/or roundness, etc. The product accuracy category is associated with the processing path so as to provide a plurality of relevances between the product accuracy category and the processing path. Then, the processing unit 6 will be utilized to process multiple workpieces according to the processing path to produce workpiece samples and to collect multiple sets of sample detection information of the multiple workpiece samples that relate to the processing path during the processing period. After the operation of sampling, it utilizes algorithm to control the noise of the detection information and convert the detection information of workpiece sample into sample characteristic data in correspondence with characteristic format. After the processing of workpiece sample is finished, the vision-based measurement unit 4 is utilized to measure the product accuracy category(ies) of the workpiece sample so as to obtain a set of quality sample data (value of accuracy). Then the quality sample data and the characteristic data of the workpiece sample are utilized to predict the interrelation between the algorithm and processing path and the product accuracy category, in order to build a prediction model for the product accuracy category. In other words, the characteristic data, quality sample data, and accuracy of workpiece that are obtained when the processing unit 6 processed the workpiece sample are utilized to form a prediction model. In short, the processing quality prediction unit 5 generates processing path for the workpiece based on the designated dimensions, tolerance, and parameters of the workpiece to be processed, and virtually predict the processing quality of the workpiece.

During the process that the processing quality prediction unit 5 is establishing or modifying the prediction model, with the assistance of the workpiece handling unit 3, the industrial camera of the vision-based measurement unit 4 rapidly takes optical photographs of the workpiece within the illumination scope of the visual light source unit and converts the captured images into dimension information, so as to facilitate the processing device 1 to enhance the measuring efficiency.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A processing apparatus with vision-based measurement for at least a workpiece, comprising:
a central control unit; and
a workpiece transporting unit, a vision-based measurement unit, a processing quality prediction unit, and a processing unit which are respectively connected to said central control unit electrically, wherein said workpiece transporting unit is controlled by said central control unit for transporting the workpiece to said vision-based measurement unit for being measured, wherein data obtained by said vision-based measurement unit from measuring the workpiece is provided to said processing quality prediction unit for conducting quality prediction, wherein said processing quality prediction unit implements a virtual processing quality prediction method to establish a quality prediction model, so as to predict the processing quality of the workpiece and to generate processing path for said processing unit to process the workpiece.

2. The processing apparatus with vision-based measurement, as recited in claim 1, wherein said workpiece transporting unit is a robot arm.

3. The processing apparatus with vision-based measurement, as recited in claim 1, wherein said vision-based measurement unit comprises an industrial camera, a visual light source unit and a computing unit, wherein said workpiece transporting unit transports the workpiece into an illumination scope of said visual light source unit, wherein said industrial camera is utilized to take photograph of the workpiece so as to obtain one or more captured images thereof, wherein said computing unit is then utilized to calculate the dimension of the workpiece.
